(19) United States
(12) Patent Application Publication
(10) Pub. No.: US 2023/0321929 A1
(43) Pub. Date: Oct. 12, 2023

(54) APPARATUS AND METHOD FOR MANUFACTURING A METAL-COMPOSITE HYBRID PART

(71) Applicants: HYUNDAI MOTOR COMPANY, Seoul (KR); KIA CORPORATION, Seoul (KR)

(72) Inventor: Junyeong Jeong, Seoul (KR)

(73) Assignees: HYUNDAI MOTOR COMPANY, Seoul (KR); KIA CORPORATION, Seoul (KR)

(21) Appl. No.: 17/956,205

(22) Filed: Sep. 29, 2022

(30) Foreign Application Priority Data
Apr. 8, 2022 (KR) 10-2022-0043826

(51) Int. Cl. B29C 70/38; B29C 70/34; B29C 70/54

(52) U.S. Cl. CPC B29C 70/386; B29L 2031/3002; B29C 70/54; B29C 70/34

(57) ABSTRACT

Disclosed are apparatus and method for manufacturing a metal-composite hybrid part. The apparatus for manufacturing a metal-composite hybrid part includes: a feeder roller feeding a composite tape to a metal base material; a heat supply device applying heat to the metal base material and the composite tape; a first pressure roller pressing and bonding the metal base material and the composite tape, bonded to each other by heat applied through the heat supply device, to each other; a cooling roller cooling the metal base material and the composite tape bonded to each other by the first pressure roller; and a second pressure roller applying heat and pressure to the metal base material and the composite tape, cooled by the cooling roller.

### CROSS-REFERENCE TO RELATED APPLICATION

This application claims priority to and the benefit of Korean Patent Application No. 10-2022-0043826 filed in the Korean Intellectual Property Office on Apr. 8, 2022, the entire contents of which are incorporated herein by reference.

### BACKGROUND

### (a) Field

The present disclosure relates to an apparatus and a method for manufacturing a metal-composite hybrid part.

### (b) Description of the Related Art

A lighter weight of a vehicle body has been an ongoing issue in a vehicle industry to improve fuel efficiency of a vehicle using an internal combustion engine and to improve a mileage of an electric or hydrogen vehicle.

An application amount of an ultra-high-strength metal sheet having an increased strength to the vehicle body has been expanded to reduce weight of the vehicle body. However, there is a limit to only applying the ultra-high-strength metal sheet to secure performance of a part of the vehicle body.

Therefore, a lightweight metal such as aluminum has been increasingly used for the vehicle body, and it is also further considered to apply a composite such as carbon fiber reinforced plastic (CFRP), which is lighter than the metal, to a part of the vehicle body.

However, the composite may have a higher price and difficulty in being bonded with the metal although having a lighter weight compared to the metal. Therefore, technologies for locally applying the composite to an area requiring higher performance have been developed.

An automated fiber placement (AFP) process technology is a representative example of the technology for locally applying the composite to the area requiring the higher performance. According to the automated fiber placement (AFP) process, a part is manufactured by coupling the composite to a metal base material as if were a fabric in such a manner that a composite tape is supplied to the metal base material through a roller while the composite tape and the metal base material are heated by a heat supply device such as a laser. The AFP process technology may be also applied to a wing part of an aircraft.

However, in case that the AFP process is applied to a martensite-structured metal having a tensile strength of about 1,470 MPa, its martensitic structure may be softened by the heat supply device for bonding, resulting in a lower strength on the contrary.

As shown in FIG. 1, it may be confirmed that the tensile strength is reduced to a level of about 1,000 MPa at a temperature of 300 degrees Celsius or more from a tensile strength-evaluation result of the metal having the tensile strength of about 1,470 MPa. In case of the AFP process, the temperature of the applied heat supply device may be more than 300 degrees Celsius, and the metal base material may inevitably have a lower physical property due to the heat supply device.

In addition, the temperature of the heat supply device may be lower to prevent the lower physical property of the metal base material. In this case, a bonding strength between the metal base material and the composite material may be lower to separate the metal base material and the bonding material from each other.

The above information disclosed in this Background section is provided only to assist in better understanding of the background of the present disclosure, and may thus include information not included in the prior art already known to those having ordinary skill in the art to which the present disclosure pertains.

### SUMMARY

The present disclosure provides an apparatus and a method for manufacturing a metal-composite hybrid part, which may provide an improved bonding strength and an increased strength.

According to an embodiment of the present disclosure, an apparatus for manufacturing a metal-composite hybrid part includes: a feeder roller feeding a composite tape to a metal base material; and a heat supply device applying heat to the metal base material and the composite tape. The apparatus further includes a first pressure roller pressing and bonding the metal base material and the composite tape to each other after the metal base material and the composite tape have been bonded to each other by heat applied through the heat supply device. The apparatus further includes: a cooling roller cooling the metal base material and the composite tape bonded to each other by the first pressure roller; and a second pressure roller applying heat and pressure to the metal base material and the composite tape which have been cooled by the cooling roller.

The heat supply device may be a xenon beam.

A cooling rate by the cooling roller may be a predetermined rate or more.

The cooling rate may be 20 degrees Celsius per second (° C./s) or more.

A temperature of the second pressure roller may be within a predetermined temperature range.

The predetermined temperature range may be from 150 degrees Celsius (° C.) to 250 degrees Celsius.

According to another embodiment of the present disclosure, a method for manufacturing a metal-composite hybrid part includes: feeding, by a feeder roller, a composite tape to a metal base material; and applying, by a heat supply device, heat to the metal base material and the composite tape. The method further includes: pressing and bonding, by a first pressure roller, the metal base material and the composite tape to each other; cooling, by a cooling roller, the metal base material and the composite tape bonded to each other; and applying, by a second pressure roller, heat and pressure to the cooled metal base material and composite tape.

A cooling rate by the cooling roller may be a predetermined rate or more.

The cooling rate may be 20° C./s or more.

A temperature of the second pressure roller may be within a predetermined temperature range.

The predetermined temperature range may be from 150 degrees Celsius to 250 degrees Celsius.

As set forth above, the apparatus and method for manufacturing a metal-composite hybrid part according to the embodiments of the present disclosure as described above may provide the improved bonding strength between the metal base material and the composite material, and the increased strength of the metal base material, by bonding the metal base material and the composite to each other and then adding the cooling process and the tempering process thereto.

### BRIEF DESCRIPTION OF THE DRAWINGS

In order that the disclosure may be well understood, there will now be described various forms thereof, given by way of example, reference being made to the accompanying drawings, in which:

FIG. 1 is a graph showing stress and strain of a metal-composite hybrid part according to a manufacturing process in the prior art;

FIG. 2 is a conceptual diagram showing an apparatus for manufacturing a metal-composite hybrid part according to an embodiment of the present disclosure;

FIG. 3 is a flowchart showing a method for manufacturing a metal-composite hybrid part according to another embodiment of the present disclosure; and

FIGS. 4A and 4B are tables comparing performances of the present disclosure and the prior art.

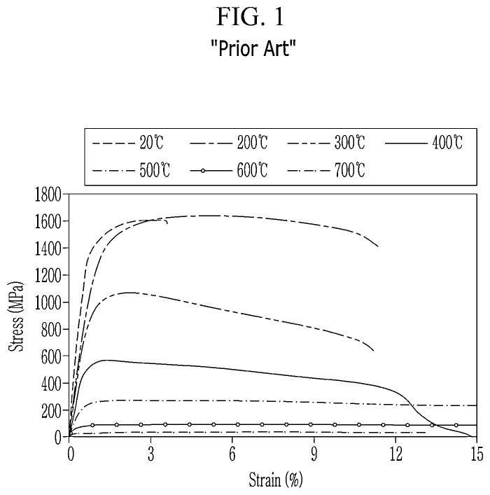

The drawings described herein are for illustration purposes only and are not intended to limit the scope of the present disclosure in any way.

### DETAILED DESCRIPTION

The present disclosure is described more fully hereinafter with reference to the accompanying drawings, in which embodiments of the present disclosure are shown. As those having ordinary skill in the art would realize, the described embodiments may be modified in various different ways, all without departing from the spirit or scope of the present disclosure.

A portion unrelated to the description is omitted to obviously describe the present disclosure, and the same or similar components are denoted by the same reference numeral throughout the specification.

The size and thickness of each component shown in the accompanying drawings are arbitrarily shown for convenience of explanation, and therefore, the present disclosure is not necessarily limited to contents shown in the accompanying drawings, and the thicknesses are exaggerated in the drawings to clearly represent several portions and regions.

When a component, device, element, or the like of the present disclosure is described as having a purpose or performing an operation, function, or the like, the component, device, or element should be considered herein as being “configured to” meet that purpose or to perform that operation or function.

Hereinafter, apparatus and method for manufacturing a metal-composite hybrid part according to the embodiments of the present disclosure are described in detail with reference to the accompanying drawings.

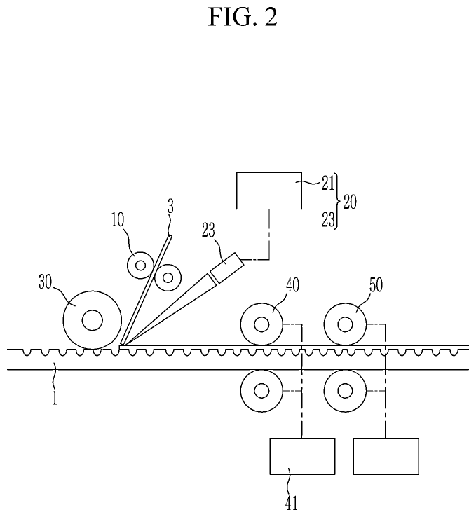

FIG. 2 is a conceptual diagram showing an apparatus for manufacturing a metal-composite hybrid part according to an embodiment of the present disclosure.

As shown in FIG. 2, an apparatus for manufacturing a metal-composite hybrid part according to an embodiment of the present disclosure may include a feeder roller 10, a heat supply device 20, a first pressure roller 30, a cooling roller 40 and a second pressure roller 50. The feeder roller 10, the first pressure roller 30, the cooling roller 40 and the second pressure roller 50 may be sequentially arranged in a direction in which a metal base material 1 is moved.

The feeder roller 10 may be disposed above a base material of a metal material (hereinafter, also referred to as ‘metal base material 1’ when necessary) moved in a predetermined direction to feed a tape-type composite (hereinafter, referred to as ‘composite tape 3’) to the metal base material.

The heat supply device 20 may apply heat to the metal base material 1 and the composite tape 3 fed to the metal base material 1 by the feeder roller 10. In other words, the heat supply device 20 may heat the metal base material 1 and the composite tape 3.

The heat supply device 20 may include a heat generator 21 generating heat, and a thermal optical system 23 applying the generated heat to the metal base material 1 and the composite tape 3. In an embodiment of the present disclosure, the heat supply device 20 may be a xenon beam, and the scope of the present disclosure is not limited thereto.

The first pressure roller 30 may be disposed downstream of the feeder roller 10, and the first pressure roller 30 may be used to bond the composite tape 3 to a surface of the metal base material 1 textured by applying pressure to the metal base material 1 and the composite tape 3, which have been heated by the heat supply device 20.

The cooling roller 40 may be disposed downstream of the first pressure roller 30, and the cooling roller 40 may cool the metal base material 1 and the composite tape bonded to each other by the first pressure roller 30. A cooling rate of the metal base material 1 and composite tape by the cooling roller 40 may be set as a predetermined rate or more. For example, the cooling rate by the cooling roller 40 may be set to be 20 degrees Celsius per second (° C./s) or more. The cooling roller 40 may be supplied with cold air from a refrigerant gas circulator 41 to cool the metal base material 1 and the composite tape 3.

The second pressure roller 50 may be disposed downstream of the cooling roller 40, and apply heat and pressure to the metal base material 1 and the composite tape 3, which are cooled by the cooling roller 40.

Hereinafter, a method for manufacturing the metal-composite hybrid part as described above according to another embodiment of the present disclosure is described in detail with reference to the accompanying drawings.

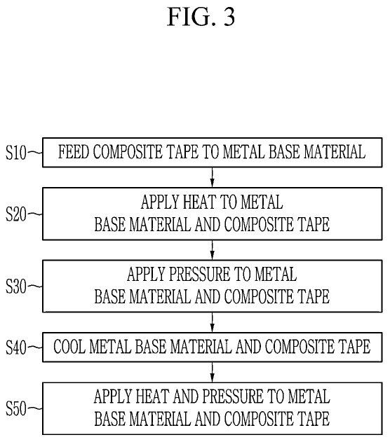

FIG. 3 is a flowchart showing the method for manufacturing a metal-composite hybrid part according to another embodiment of the present disclosure.

As shown in FIG. 3, a composite tape 3 may be fed to a metal base material 1 moved through a feeder roller 10 in a predetermined direction (Step S10).

A heat supply device 20 applies heat to the metal base material 1 and the composite tape 3 (Step S20) after the composite tape 3 is fed to a surface of the metal base material 1 textured by a feeder roller 10.

Pressure may be applied by the first pressure roller 30 to the heated metal base material 1 and the composite tape 3 to bond the metal base material 1 and the composite tape 3 to each other (Step S30) after the metal base material 1 and the composite tape 3 are heated by the heat supply device 20.

The bonded metal base material 1 and the composite tape 3 may be cooled by the cooling roller 40 (Step S40) after the metal base material 1 and the composite tape 3 are bonded to each other by the first pressure roller 30. Here, a cooling rate by the cooling roller 40 may be set to be 20° C./s or more. In case that the cooling rate by the cooling roller 40 is less than 20° C./s, carbon may be diffused in the metal base material 1 due to a low cooling rate to aggregate precipitates such as cementite, thereby lowering a physical property of the metal base material 1. Therefore, an appropriate cooling rate by the cooling roller 40 may be important.

Heat and pressure may be applied to the cooled metal base material 1 and composite tape by a second pressure roller 50 (Step S50) after the metal base material 1 and the composite tape are cooled by the cooling roller 40. A martensitic structure of the metal may be tempered to improve toughness of the metal base material 1 in case that heat and pressure are applied to the metal base material 1 by the second pressure roller 50. In addition, it may strengthen a bonding strength between the metal base material 1 and the composite tape 3 which may be lower due to a difference in the thermal expansion coefficients of the metal and composite in case that the metal base material 1 and the composite tape 3 are cooled by the cooling roller 40.

A temperature of the second pressure roller 50 may be within a predetermined temperature range, for example, between 150 degrees Celsius and 250 degrees Celsius when the metal base material 1 is tempered using the second pressure roller 50. A tempering effect may be insignificant due to a low temperature in case that the temperature of the second pressure roller 50 is less than 150 degrees Celsius. The metal may have a lower physical property in case that the temperature of the second pressure roller 50 is more than 250 degrees Celsius, and damage may occur in the composite tape 3 bonded to the surface of the metal base material 1. Therefore, it may be important for the second pressure roller 50 to have a tempering temperature determined within an appropriate temperature range.

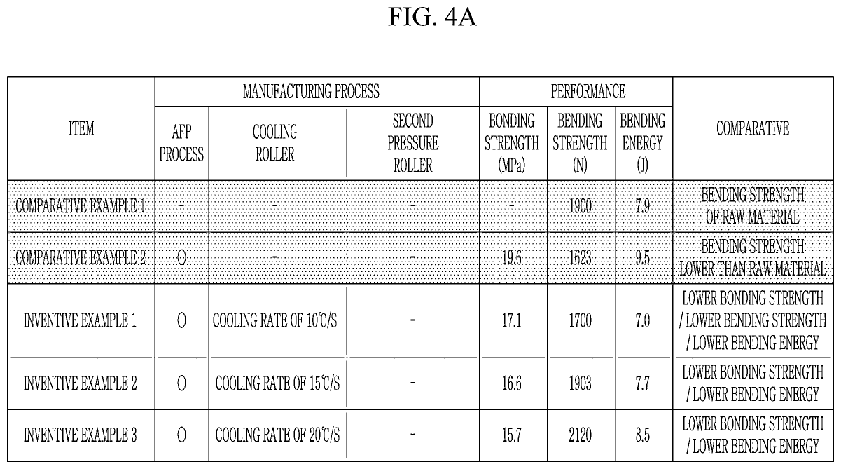

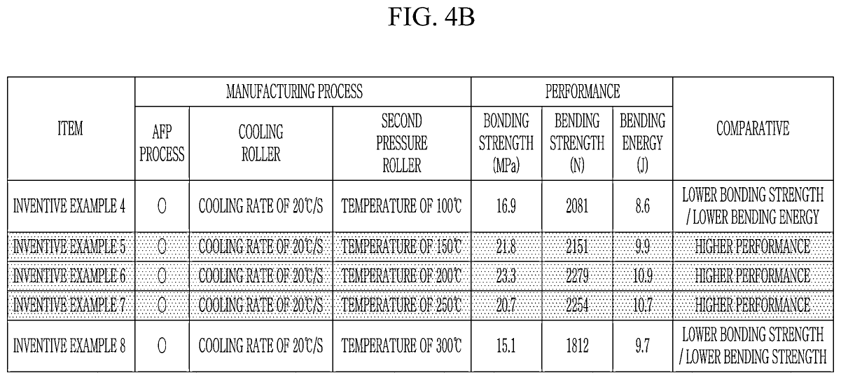

FIGS. 4A and 4B are tables comparing performances of the present disclosure and the prior art.

In a performance test shown in FIGS. 4A and 4B, the metal base material 1 uses a steel plate having a thickness of 1.0 mm and a tensile strength of 1,470 MPa, and the composite uses a unidirectional (UD) tape including 50% carbon fiber reinforced plastics (CFRP) and 50% polyamide 6 (PA6).

All three layers of the UD tape are patch-bonded to one another, and performance evaluations (e.g., bonding strength evaluation and bending strength evaluation) are performed with variables such as the cooling rate by the cooling roller 40 in the cooling process, and the temperature of the second pressure roller 50 in the tempering process performed using the second pressure roller 50.

Referring to FIGS. 4A and 4B, it may be seen that due to the thermal softening, the metal base material 1 has a bending strength lower by about 15% compared to that of a raw material (see Comparative Example 1) in case that the metal base material 1 and the composite tape 3 are bonded to each other by using only the prior AFP process (see Comparative Example 2).

It may be seen that the softening of the metal base material 1 is prevented in case that the cooling process by the cooling roller 40 is added (see Inventive Examples 1 to 3). Accordingly, the metal base material 1 has a higher bending strength, a lower bonding strength with the metal-composite and lower bending energy, compared to those of Comparative Example 2. This result is due to the bonding strength is lower due to the difference in the thermal expansion coefficients of the metal base material 1 and the composite during cooling the metal base material 1, and brittleness occurring in the metal base material 1 due to rapid cooling.

It may be seen that the metal base material 1 still has the lower bonding strength and the lower bending energy compared to those of Comparative Example 2 in case that the tempering process by the second pressure roller 50 is added after the cooling process by the cooling roller 40, and the tempering temperature is 100 degrees Celsius (see Inventive Example 4). It is confirmed that this phenomenon occurs because the martensite structure, which becomes more brittle in the cooling process due to the low tempering temperature, is not recovered and the lower bonding strength is not improved.

It may be seen that both the bonding strength and bending performance of the metal base material 1 are higher than those of Comparative Examples in case that the tempering temperature is between 150 degrees Celsius and 250 degrees Celsius (see Inventive Examples 5 to 7).

It may be seen that the metal base material 1 has the bonding strength and bending strength lower than those of Comparative Examples in case that the tempering temperature is 300 degrees Celsius (see Inventive Example 8). It may be seen that ferrite is formed in the form of precipitates in the metal due to the increased tempering temperature to lower its physical property, and the metal base material 1 also has the lower bonding strength as the bonded composite is reheated to a high temperature.

As described above, according to the embodiments of the present disclosure, it is possible to bond the metal base material 1 and the composite tape 3 to each other, and then inhibit or prevent the softening of the metal base material 1 through the cooling process, and secure the tensile strength of the metal base material 1 through the tempering process.

Accordingly, it is possible to reduce the overall weight of the vehicle by applying the manufacturing technology according to the present disclosure to the parts of the vehicle, requiring local strength.

While the present disclosure has been described in connection with what is presently considered to be practical embodiments, it should be understood that the present disclosure is not limited to the disclosed embodiments. On the contrary, it is intended to cover various modifications and equivalent arrangements included within the spirit and scope of the present disclosure.

### DESCRIPTION OF SYMBOLS

1: metal base material

3: composite tape

10: feeder roller

20: heat supply device

21: heat generator

23: thermal optical system

30: first pressure roller

40: cooling roller

41: refrigerant gas circulator

50: second pressure roller

What is claimed is:

1. An apparatus for manufacturing a metal-composite hybrid part, the apparatus comprising:
a feeder roller configured to feed a composite tape to a metal base material;
a heat supply device configured to apply heat to the metal base material and the composite tape;
a first pressure roller configured to press and bond the metal base material and the composite tape to each other after being bonded to each other by heat applied through the heat supply device;
a cooling roller configured to cool the metal base material and the composite tape bonded to each other by the first pressure roller; and
a second pressure roller configured to apply heat and pressure to the metal base material and the composite tape after being cooled by the cooling roller.

2. The apparatus of claim 1, wherein the heat supply device is a xenon beam.

3. The apparatus of claim 1, wherein
a cooling rate by the cooling roller is a predetermined rate or more.

4. The apparatus of claim 3, wherein the predetermined rate is 20 degrees Celsius per second (° C./s).

5. The apparatus of claim 1, wherein
a temperature of the second pressure roller is within a predetermined temperature range.

6. The apparatus of claim 5, wherein
the predetermined temperature range is from 150 degrees Celsius to 250 degrees Celsius.

7. A method for manufacturing a metal-composite hybrid part, the method comprising:
feeding, by a feeder roller, a composite tape to a metal base material;
applying, by a heat supply device, heat to the metal base material and the composite tape;
pressing and bonding, by a first pressure roller, the metal base material and the composite tape to each other;
cooling, by a cooling roller, the metal base material and the composite tape bonded to each other; and
applying, by a second pressure roller, heat and pressure to the cooled metal base material and composite tape.

8. The method of claim 7, wherein
a cooling rate by the cooling roller is a predetermined rate or more.

9. The method of claim 8, wherein
the predetermined rate is 20 degrees Celsius per second (° C./s).

10. The method of claim 7, wherein
a temperature of the second pressure roller is within a predetermined temperature range.

11. The method of claim 10, wherein
the predetermined temperature range is from 150 degrees Celsius to 250 degrees Celsius.
